(19) United States
(12) Patent Application Publication
(10) Pub. No.: US 2013/0333534 A1
(43) Pub. Date: Dec. 19, 2013

(54) Safety Knife Handle With Wire Blade

(71) Applicant: Earl Votolato, Newport Beach, CA (US)

(72) Inventor: Earl Votolato, Newport Beach, CA (US)

(21) Appl. No.: 13/527,411

(22) Filed: Jun. 19, 2012

(51) Int. Cl. B26B 27/00; B26D 1/44

(52) U.S. Cl. 83/13; 83/651.1

(57) ABSTRACT

A safety knife preferably for cutting food items such as vegetables, bread and meat without lacerations includes a handle portion and an extension. The extension includes two terminal ends, located near the handle and away from the handle, respectively. A wire blade bearing cutting elements is drawn taut between the two terminal ends. The extension includes a bevel portion, the leading edge of which travels immediately behind the wire blade. The wire blade is held under enough tension to avoid deforming when drawn through food items in a back-and-forth motion, and the bevel helps to separate items being cut. This reduces drag on the wire blade when using the knife and keeps the user's hands and fingers away from the wire blade.

### BACKGROUND

Knives and saws are well known in the art, including those having a blade held taught between two ends of an extension portion, anchored only at those two locations as is the case with hack saws, and coping saws. These apparatus typically use blades that, while flexible, have a leading edge bearing teeth. Knives based on such a design are prone to injure users, similar to knives with rigid blades.

U.S. Pat. No. 1,492,134 to Kyle, discloses a food slicing knife having a handle and an extension. A conventional blade with teeth is located between two ends of the extension. Although Kyle allows users to replace old blades when they become dull, it does not address hazards attending conventional toothed blades.

U.S. Publication No. 2005/0278957 to McCullough discloses a cutting apparatus having a wire blade pulled taught between two sections of a handle and offset from the blade roller. Although the wire blade of McCullough helps prevent lacerations, the blade location in reaction to the handle renders it incapable of making many conventional cuts, and from cutting through most food items.

U.S. Pat. No. 1,577,381 to Sprague discloses a hack saw having a blade with a support adjacent its trailing end. Although Sprague can be used for conventional cuts through material, the blade position and the blade having teeth along its leading edge creates a laceration risk similar to Kyle and conventional rigid-blade knives.

U.S. Pat. No. 2,959,203 to Dreier discloses a hack saw having an adjustable blade fixed to one end of an extension and having a sliding mechanism along another end of the extension. Dreier includes a conventional blade which has the disadvantages of both Kyle and Sprague.

### SUMMARY

An improved safety knife includes a handle portion and an extension portion. The extension portion has a first terminal end and a second terminal end for holding a blade taut between the first and second terminal ends. The extension portion includes a bevel with its leading edge adjacent the blade, extending substantially the length of the blade. Preferably, the blade is made of flexible wire, in one embodiment having cutting elements along its length and around the circumference of the wire.

Preferably the blade is approximately thirty (30) centimeters long, and held between five (5) and twenty (20) millimeters from the bevel, which may be two-sided and tapered depending on the desired characteristics of the knife. Anchors attached to either end of the blade securely connect it to the first terminal end and second terminal end. In order to store the knife, the handle may include a hole for accommodating a hook or peg.

To use the knife, the handle and extension portions are provided with a wire blade. The blade is drawn taut substantially directly in front of the bevel portion of the extension. A user grasps the knife by the handle and using a back-and-fourth motion, cuts through a food item or other item to be cut, and as the blade travels through the item, the bevel separates the item at the cut to minimize drag on the knife.

### BRIEF DESCRIPTION OF THE FIGURES

FIG. 1 is a perspective view of a safety knife having a wire blade and bevel.

FIG. 2 is a cut-away view of the safety knife.

FIG. 3 is a perspective view of an alternative embodiment of the safety knife.

FIG. 4 is a cut-away view of the alternative embodiment.

FIGS. 5A-5C are various embodiments of anchoring mechanisms for a blade of the safety knife.

### DESCRIPTION

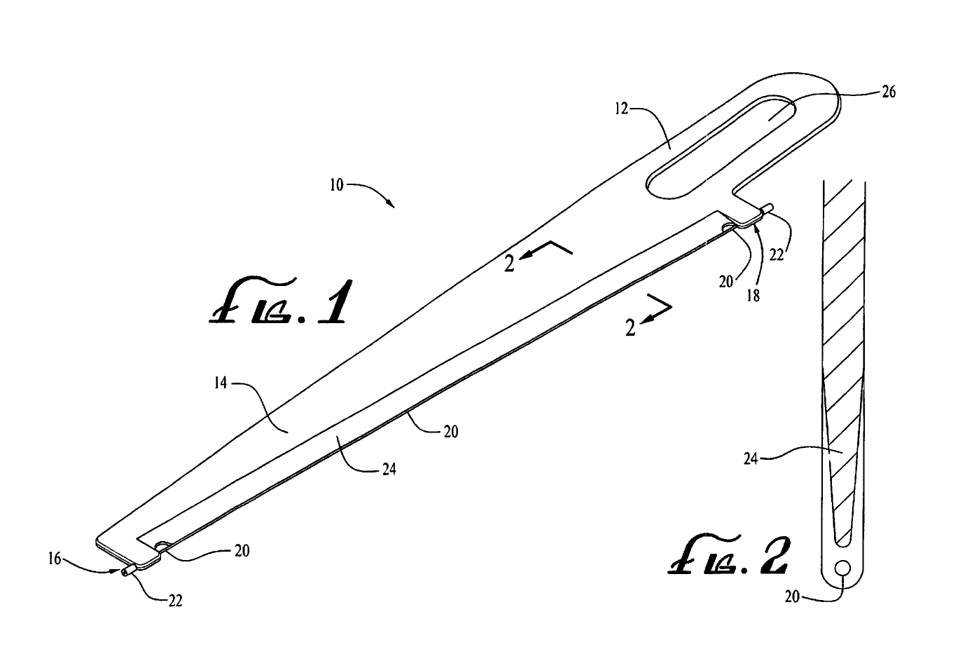

Referring to FIGS. 1 and 2, an improved safety knife 10, preferably for cutting foods such as vegetables, bread, meat and other items is shown and described. The knife 10 comprises a handle 12 and an extension 14 extending from the handle 12. The handle is characterized by a hole 26 for hanging the knife 10 on a peg or hook (not shown). The extension 14 is characterized by a first terminal end 16 distal to the handle 12 and a second terminal end 18 proximal to the handle 12. A blade 20 attached between the first terminal end 16 and second terminal end 18 is held under a tensile load between the terminal ends 16, 18 sufficiently so that the blade 20 remains substantially linear when slicing through food items (not shown).

Still referring to FIGS. 1 and 2, the blade 20 extends through the first terminal end 16 and second terminal end 18, and is held in place adjacent the extension 14. Preferably, the blade 20 is approximately thirty (30) centimeters long, and is disposed between five (5) and twenty (20) millimeters from the extension 14. In order to hold the blade 20 under tension, anchors 22 are disposed at either end of the blade 20. Referring to FIGS. 5A through 5C, the anchors 22 may comprise a variety of known anchor types, including an eyelet 30 or a terminal 32 crimped onto the blade 20. In the alternative, the blade 20 may comprise a looped end 34 sufficient for holding the blade 20 under a tensile load.

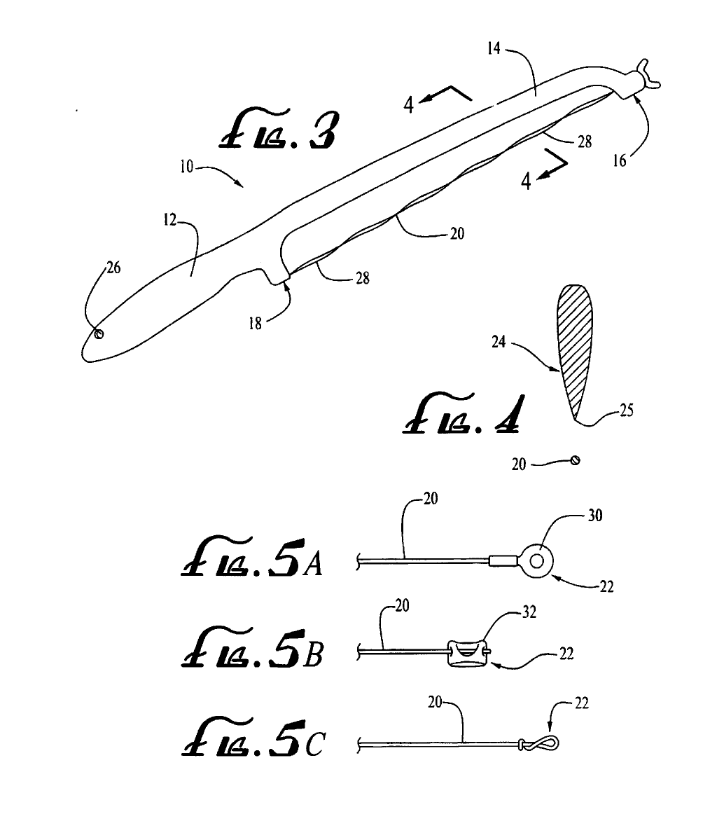

Referring to FIGS. 3 and 4 an alternate embodiment is shown. The blade 20 comprises wire and may have cutting elements 28 disposed around its circumference. In this manner, the blade 20 will slice through an item to be cut regardless of orientation relative to the item. To reduce drag during slicing, the extension 14 includes a bevel 24 adjacent the blade 20. The leading edge 23 of the bevel 24 is proximal the blade 20 as mentioned earlier, and in the illustrated embodiment comprises a two-sided bevel 24.

Still referring to FIGS. 3 and 4, the bevel 24 may be wing-shaped in profile, which reduces drag on the knife 10 while slicing. In this embodiment, the knife 10 may be constructed with a greater thickness to facilitate increased comfort for the user. In the illustrated embodiment, the handle 12 also has a greater thickness. Due to the increased thickness, a smaller hole 26 is drilled through the handle, thereby allowing a string or tether (not shown) to extend through the handle 12, facilitating hanging the knife 10.

The knife 10 and its components having been shown and identified, use of the knife 10 will now be described. In order to use the knife 10, a blade 20 comprising a wire with cutting elements 28 disposed thereon is anchored between a first terminal end 16 and second terminal end 18 of an extension 14 coupled with a handle 12. Installing the blade 20 may be accomplished by the knife 10 manufacturer or by an end user. Once the blade 20 is installed on the extension 14, drawn taught between the terminal ends 16, 18, and disposed substantially in front of the bevel 24, a user engages an item to be cut with a back-and-forth motion, causing the knife 10 to slice through the item. As the blade 20 travels through the item, the bevel 24 separates the item to reduce drag on the knife 10 as cutting continues.

While the apparatus and method have been described in detail with reference to specific embodiments thereof, it will be apparent to one skilled in the art that various changes and modifications can be made therein without departing from the spirit and scope thereof. Thus, it is intended that the present description cover the modifications and variations of the apparatus and method provided they come within the scope of the appended claims and their equivalents.

What is claimed is:

1. A safety knife for cutting food items comprising:
a handle coupled to an extension;
the extension having a first terminal end proximate to the handle and a second terminal end distal from the handle;
a wire blade under tensile load anchored between the first terminal end and the second terminal end; and
a bevel disposed on the extension, having a leading edge adjacent the blade.

2. The knife of claim 1 wherein the wire blade has raised cutting elements.

3. The knife of claim 2 wherein the cutting elements extend circumferentially around the wire blade.

4. The knife of claim 1 wherein the wire blade is located from five (5) to twenty (20) millimeters from the bevel.

5. The knife of claim 1 wherein the wire blade is approximately thirty (30) centimeters long.

6. The knife of claim 1 wherein the bevel is at least one sided.

7. The knife of claim 1 wherein the wire blade is securely connected to the first terminal end and the second terminal end by anchors.

8. The knife of claim 1 wherein a hole is disposed in the handle.

9. A safety knife comprising:
a handle having an elongate extension;
the extension having a first terminal end proximate the handle and a second terminal end distal from the handle;
a wire blade having cutting elements, anchored between the terminal ends for holding the wire blade under tensile load;
a bevel on the extension disposed between five (5) and twenty (20) millimeters behind the wire blade.

10. A method of safely cutting food such as vegetables, bread, or meat comprising the steps of:
providing a knife having a handle and an extension having a bevel;
providing a wire blade;
connecting the wire blade to the extension;
bringing the wire blade under tensile load;
maintaining the wire blade under tensile load directly in front of the bevel; and
cutting with a back-and-forth motion;
whereby the wire blade cuts through the food while the bevel separates the food after cutting.
